(19) United States
(12) Patent Application Publication
(10) Pub. No.: US 2011/0109883 A1
(43) Pub. Date: May 12, 2011

(54) CEILING-MOUNTING SUSPENSION DEVICE FOR PROJECTOR

(76) Inventor: Kosuke Ito, Tokyo (JP)

(21) Appl. No.: 12/737,150

(22) PCT Filed: Jun. 18, 2008
(86) PCT No.: PCT/JP2008/061156

§ 371 Date: Dec. 13, 2010

(51) Int. Cl. G03B 21/16; F16M 13/02; B01D 46/00

(52) U.S. Cl. 353/61; 248/343; 55/385.1

(57) ABSTRACT

A ceiling-mounting suspension device (1) for a projector according to the present invention includes a ceiling-mounting suspension metal fitting unit having a fixing part to be fixed to a ceiling and a holding part configured to hold a projector (11), and a dust prevention unit (3) detachable from and attachable to said ceiling-mounting suspension metal fitting unit, said dust prevention unit including a dustproof filter (3a).

### TECHNICAL FIELD

The present invention relates to a ceiling-mounting suspension device for a projector.

### BACKGROUND ART

In recent years, ceiling suspended projectors are installed in conference rooms or the like and used for presentation as well as installed in halls, stores, or the like from time to time, the applications of which are diverse. In consequence, ceiling suspended projectors are increasingly installed in dusty places.

Inside projectors, a cooling fan is generally disposed as a ventilating unit that releases the heat generated from a light source. An air intake port and an air outlet port are formed on a housing of the projector, in which a cooling fan takes the air that is outside the housing from the air intake port into the inside of the housing and releases the air inside the housing from the air outlet port to the outside of the housing, the temperature of the air rising due to the heat which was generated from the light source.

When taking the air that is outside the housing from the air intake port into the inside of the housing by the cooling fan, dust or the like contained in the air, which has entered the housing, sometimes causes problems such as shortened lifetime of an optical engine, electronic components, or the like disposed inside the housing. Because of this, generally, an air filter is mounted on the air intake port to prevent dust or the like from entering the housing.

FIG. 1A is a perspective view of a ceiling suspended projector related to the invention of the present application, and FIG. 1B is a front perspective view of the projector. Projector 11 has projector lens 13 that projects images, and housing 12 has air intake port 12a formed on one side thereof and air outlet port 12b formed on the other side.

FIG. 2A is a bottom perspective view of the projector shown in FIG. 1A, 1B, and FIG. 2B is a cross sectional view along line A-A′ shown in FIG. 2A. Light source unit 15 that emits rays, optical engine 16 that converts the rays emitted from light source unit 15 into projection images and projects the images through projector lens 13, and a ventilating unit (not shown) that takes the air outside housing 12 from air intake port 12a into the inside of housing 12 are provided inside housing 12 of projector 11. Further, air filter 14 is disposed on the inner wall surface of housing 12 at the position at which air filter 14 covers air intake port 12a.

FIG. 3 is a front view of a ceiling-mounting suspension device for a projector related to the invention of the present application. Ceiling-mounting suspension device 101 has fixing part 102a to be fixed to a ceiling, and holding part 102b that fixes the top side of housing 12 of the projector.

FIG. 4 is a front perspective view of the ceiling-mounting suspension device shown in FIG. 3, on which the projector shown in FIG. 1A, 1B is mounted. Projector 11 is held by holding part 102b in which the top side of housing 12 is fixed to holding part 102b of ceiling-mounting suspension device 101.

For projector 11, it is necessary to perform maintenance on the inside of housing 12 such as the cleaning or replacement of air filter 14 at regular time intervals so as not to deteriorate heat dissipation properties due to clogged air filter 14 because air filter 14 excessively collects dust or the like. More particularly, when projector 11 is installed at dusty places, frequent maintenance is needed for the inside of housing 12.

However, for ceiling suspended projectors, because it is necessary to demount projectors from their ceiling-mounting suspension devices in order to perform maintenance on the inside of their housings, ceiling suspended projectors require more effort for maintenance on the inside of the housings than floor-standing projectors do. For this reason, desirably, ceiling hung projectors are configured such that the frequency of maintenance on the inside of the housing can be reduced.

FIG. 5 is a front perspective view of a projector adapted for reducing the frequency of maintenance on the inside of the housing. On the outer wall surface of housing 12 of projector 11, dust prevention unit 111 is mounted at the position at which dust prevention unit 111 covers air intake port 12a such that the air, from which dust or the like is removed because dust prevention unit 111 collects dust or the like, is delivered to air intake port 12a.

Because dust prevention unit 111, which is mounted on projector 11, can decrease dust or the like that is contained in the air to be delivered to air filter 14, the occurrences of clogging are reduced in air filter 14 because it excessively collects dust or the like. Consequently, projector 11 mounted with dust prevention unit 111 can reduce the frequency of maintenance on the inside of housing 12. Further, because dust prevention unit 111 is detachable and attachable without it being necessary to demount projector 11 from ceiling-mounting suspension device 101, no effort is required even in the housing in which it is necessary to frequently clean or replace dust prevention unit 111.

However, for projector 11 mounted with dust prevention unit 111, maintenance on the inside of housing 12 cannot be performed until projector 11 is demounted from ceiling-mounting suspension device 101 and dust prevention unit 111 is further demounted from housing 12. Consequently, although projector 11 mounted with dust prevention unit 111 can reduce the frequency of maintenance, amount of time used by the work processes are increased at the time of maintenance.

A technique related to the invention of the present application is described in JP2006-189549A.

### DISCLOSURE OF THE INVENTION

It is an object of the present invention to provide a ceiling-mounting suspension device for a projector that contributes to improved maintenance of the projector.

A ceiling-mounting suspension device for a projector according to the present invention includes a ceiling-mounting suspension metal fitting unit having a fixing part to be fixed to a ceiling and a holding part configured to hold a projector, and a dust prevention unit detachable from and attachable to the ceiling-mounting suspension metal fitting unit, the dust prevention unit including a dustproof filter.

### BRIEF DESCRIPTION OF THE DRAWINGS

FIG. 1A, 1B show a perspective view and a front perspective view of a ceiling suspended projector related to the invention of the present application;

FIG. 2A, 2B show a bottom perspective view of the projector shown in FIG. 1A, 1B and a cross sectional view along line A-A;

FIG. 3 is a front view of a ceiling-mounting suspension device for a projector related to the invention of the present application;

FIG. 4 is a front perspective view of the ceiling-mounting suspension device shown in FIG. 3, on which the projector shown in FIG. 1A, 1B is mounted;

FIG. 5 is a front perspective view of the ceiling-mounting suspension device shown in FIG. 3, on which the projector having a dust prevention unit related to the invention of the present application is mounted;

FIG. 6A, 6B show a perspective view and a front perspective view of a ceiling-mounting suspension device for a projector according to an embodiment of the present invention;

FIG. 7A, 7B show a side view and a top view of a dust prevention unit of the ceiling-mounting suspension device shown in FIG. 6A, 6B;

FIG. 8A, 8B show a perspective view and a front perspective view of the ceiling-mounting suspension device shown in FIG. 6A, 6B, on which the projector shown in FIG. 1A, 1B is mounted;

FIG. 9 is a front perspective view of the ceiling-mounting suspension device shown in FIG. 8A, 8B; and

FIG. 10 is a cross sectional view of the dust prevention unit along line B-B′ shown in FIG. 7A, 7B.

### BEST MODE FOR CARRYING OUT THE INVENTION

Next, an embodiment of the present invention will be described with reference to the drawings.

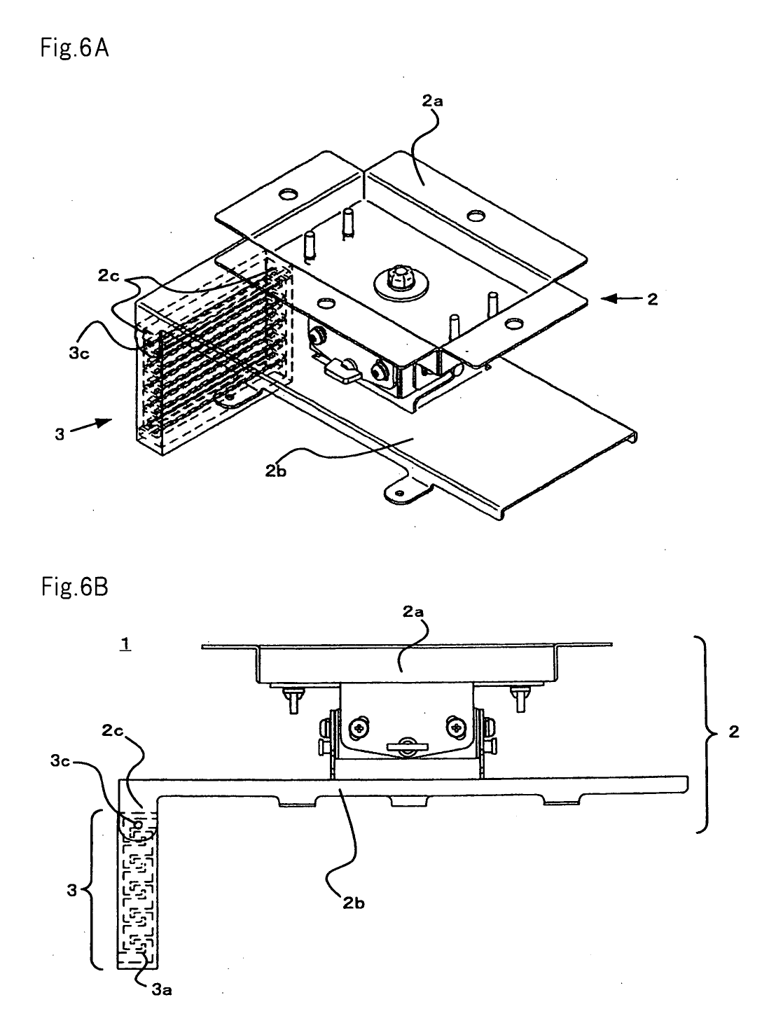

FIG. 6A is a perspective view of a ceiling-mounting suspension device for a projector according to an embodiment of the present invention, and FIG. 6B is a front perspective view of the ceiling-mounting suspension device.

Ceiling-mounting suspension device 1 has ceiling-mounting suspension metal fitting unit 2 that holds the projector, and dust prevention unit 3 that collects dust or the like contained in the air. Ceiling-mounting suspension metal fitting unit 2 has fixing part 2a to be fixed to a ceiling, and holding part 2b that fixes the top side of the housing of the projector. Dust prevention unit 3 has dustproof filter 3a, and is detachable from and attachable to holding part 2b.

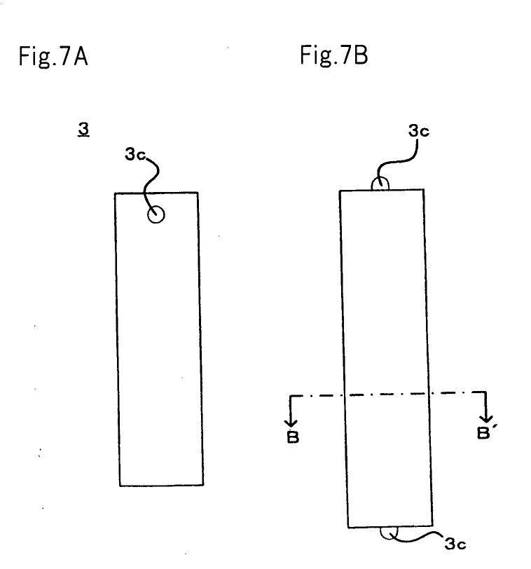

FIG. 7A is a side view of the dust prevention unit of the ceiling-mounting suspension device shown in FIG. 6A, 6B, and FIG. 7B is a top view of the dust prevention unit. Engaging projection 3c is formed on each of two side surfaces on the upper part of dust prevention unit 3.

As shown in FIG. 6A, 6B, on one side end part of holding part 2b of ceiling-mounting suspension metal fitting unit 2, engaging pieces 2c each having an engaging hole therein are formed at two ends in the direction of the projector projecting images when the projector is mounted on holding part 2b. Dust prevention unit 3 is held by ceiling-mounting suspension metal fitting unit 2 in which the two side surfaces on the upper part thereof are sandwiched between two engaging pieces 2c and each engaging projection 3c is mated with each engaging hole in engaging piece 2c. Dust prevention unit 3 can be rotationally moved with respect to ceiling-mounting suspension metal fitting unit 2 about engaging projections 3c mated with the engaging holes in engaging pieces 2c.

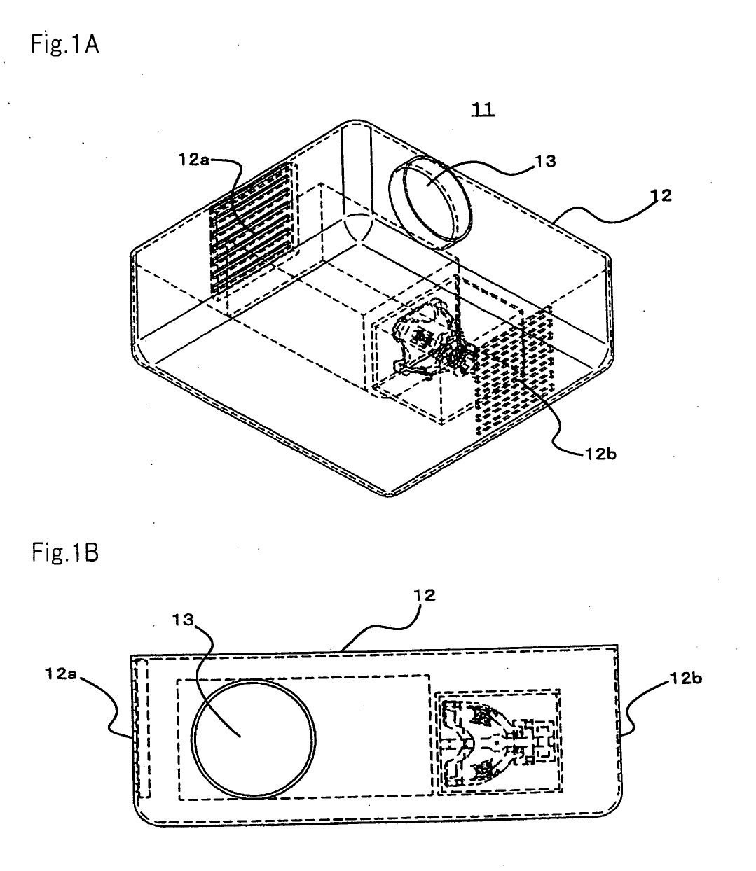

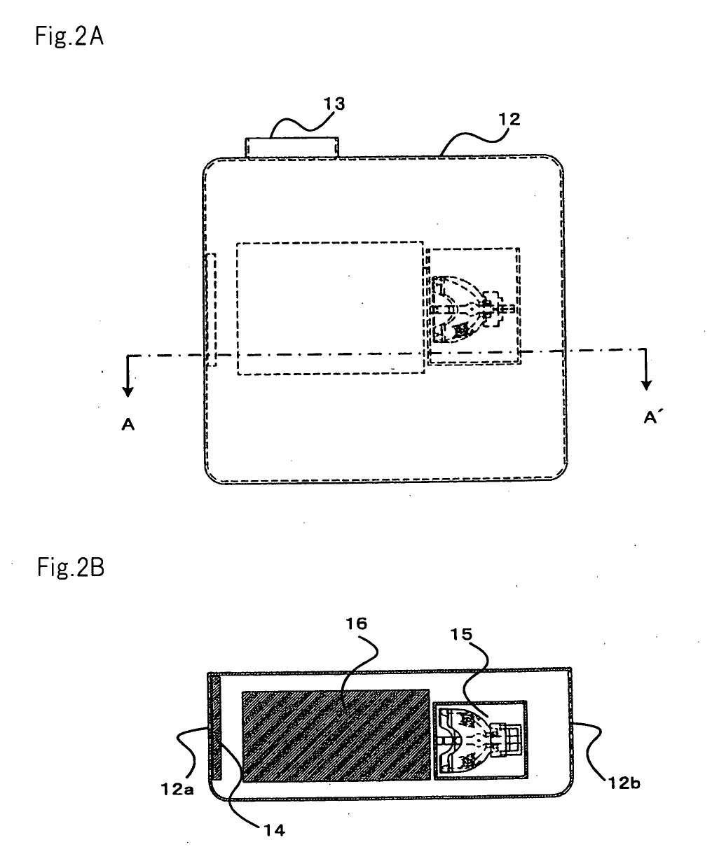

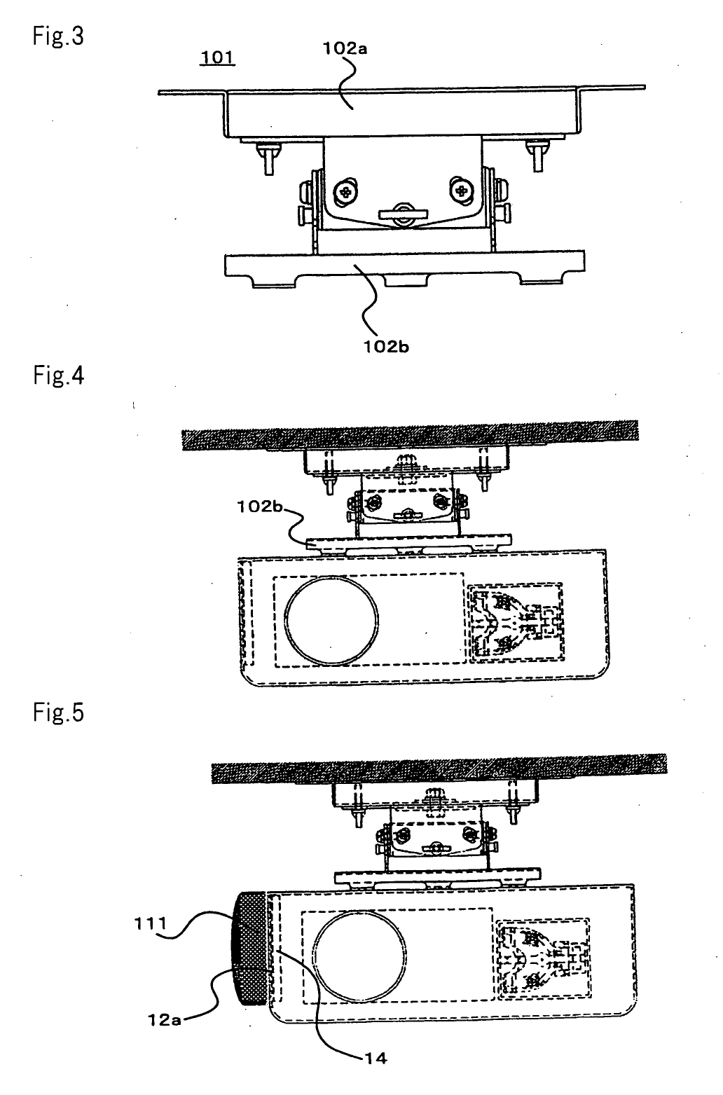

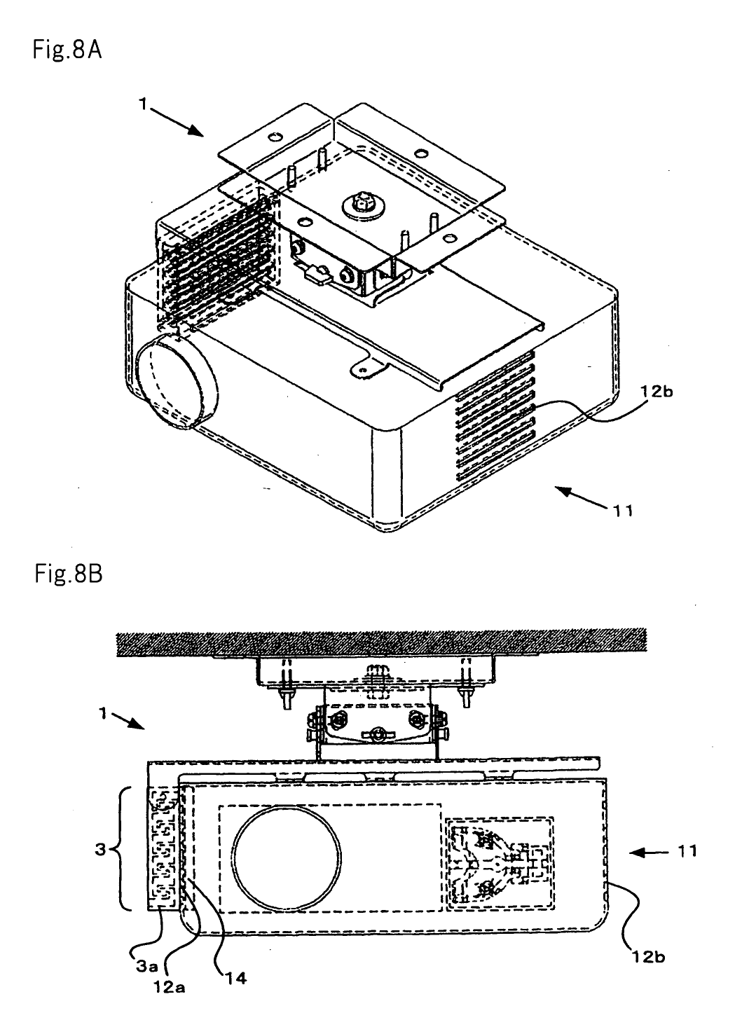

FIG. 8A is a perspective view of the ceiling-mounting suspension device shown in FIG. 6A, 6B, on which the projector shown in FIG. 1A, 1B related to the invention of the present application is mounted, and FIG. 8B is a front perspective view of the ceiling-mounting suspension device.

Dust prevention unit 3 of ceiling-mounting suspension device 1 is disposed at the position at which dust prevention unit 3 covers air intake port 12a of projector 11 from the outside of housing 12. Ceiling-mounting suspension device 1 is configured such that the air, from which dust or the like is removed by dust prevention unit 3 because it collects dust or the like, is taken from air intake port 12a into the inside of housing 12 by the ventilating unit of projector 11. Consequently, the occurrences of clogging are reduced in air filter 14 of projector 11 because air filter 14 excessively collects dust or the like. Accordingly, projector 11 held by ceiling-mounting suspension device 1 can reduce the frequency of maintenance on the inside of housing 12.

Dust prevention unit 3 is held only by ceiling-mounting suspension metal fitting unit 2, and it can be easily removed from ceiling-mounting suspension metal fitting unit 2 by releasing engaging projection 3c from the engaging hole in engaging piece 2c. Thus, because dust prevention unit 3 is readily detachable and attachable without demounting projector 11 from ceiling-mounting suspension metal fitting unit 2, maintenance is easy even in the housing in which it is necessary to frequently clean or replace dust prevention unit 3.

Further, because dust prevention unit 3 is held only by ceiling-mounting suspension metal fitting unit 2, for projector 11 mounted on ceiling-mounting suspension device 1, maintenance on the inside of housing 12 can be performed as only projector 11 is demounted from ceiling-mounting suspension metal fitting unit 2, without removing dust prevention unit 3 from ceiling-mounting suspension metal fitting unit 2. Consequently, amount of time used by the work processes at the time of maintenance on the inside of housing 12 of projector 11 are not increased.

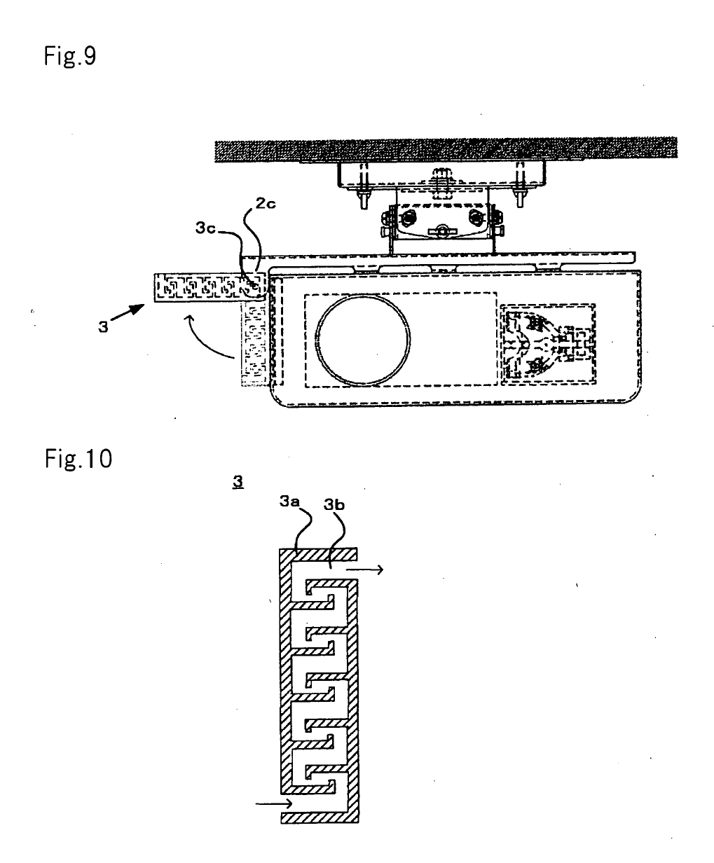

Furthermore, as shown in FIG. 9, when demounting projector 11 from ceiling-mounting suspension metal fitting unit 2, dust prevention unit 3 can be rotationally moved upward about engaging projections 3c and separated from air intake port 12a of projector 11. Consequently, dust prevention unit 3 can be prevented from being an obstacle when demounting projector 11 from ceiling-mounting suspension metal fitting unit 2.

As discussed above, because ceiling-mounting suspension device 1 according to the embodiment can reduce the frequency of maintenance with no increase in amount of time used by the work processes at the time of maintenance of the projector, it contributes to an improved maintenance of the projector.

FIG. 10 is a cross sectional view of the dust prevention unit along line B-B′ shown in FIG. 7B. Dustproof filter 3a accommodated in dust prevention unit 3 has air channel 3b formed in a labyrinth structure. A labyrinth structure refers to an intricately bent, mazelike structure.

Because dust or the like contained in the air passing through the bent portions of channel 3b in dustproof filter 3a in the labyrinth structure cannot quickly change the traveling direction along the air flow in accordance with the law of inertia, the dust collides against the inner wall surfaces of channel 3b. Dustproof filter 3a is made of a porous material, and collects dust or the like having collided against the inner wall surfaces of channel 3b. Consequently, in the air having passed through channel 3b in dustproof filter 3a, dust or the like has been removed. As described above, because channel 3b in dustproof filter 3a has a labyrinth structure, dustproof filter 3a can effectively remove dust or the like contained in the air.

Furthermore, channel 3b in dustproof filter 3a is formed such that the cross sectional area orthogonal to the direction of the flowing air greatly changes at the bent portions. Because of this, in the course of the air passing through channel 3b, the flow rate of the air greatly changes according to the changes in the cross sectional area of channel 3b based on Bernoulli's theorem. More specifically, the flow rate of the air suddenly drops at the portions at which the cross sectional area of channel 3b becomes larger.

When the flow rate of the air suddenly drops at the bent portions of channel 3b, dust or the like contained in the air does not tend to receive the influence of the air flow, and tries to move at the velocity corresponding to the flow rate of the air before the flow rate drops since the dust is not able to quickly change the rate of travel in accordance with the law of inertia. Consequently, in dustproof filter 3a, dust or the like contained in the air tends to collide against the inner wall surfaces of channel 3b.

In addition, because the dustproof filter having a channel in the labyrinth structure can accumulate a greater amount of dust and dirt than other mesh filters, reducing the frequency of filter replacement is made possible.

1. A ceiling-mounting suspension device for a projector, comprising:
a ceiling-mounting suspension metal fitting unit having a fixing part to be fixed to a ceiling and a holding part configured to hold a projector; and
a dust prevention unit detachable from and attachable to said ceiling-mounting suspension metal fitting unit, said dust protecting unit including a dustproof filter.

2. The ceiling-mounting suspension device for a projector according to claim 1, wherein
said projector includes a housing having an air intake port formed thereon, and a ventilating unit configured to take air outside said housing from said air intake port into the inside of said housing, and
said dust prevention unit is disposed at a position at which said dust prevention unit covers said air intake port from the outside of said housing when said projector is mounted on said holding part.

3. The ceiling-mounting suspension device for a projector according to claim 1, wherein
said dustproof filter has an air channel formed therein, the air channel having a labyrinth structure.

4. The ceiling-mounting suspension device for a projector according to claim 2, wherein
said dustproof filter has an air channel formed therein, the air channel having a labyrinth structure.
